(19) United States
(12) Patent Application Publication
(10) Pub. No.: US 2005/0266133 A1
(43) Pub. Date: Dec. 1, 2005

(54) Method of preparing fried rice

(75) Inventors: Teruo Kobayashi, Osaka (JP); Tatuya Yamamoto, Gunma (JP); Fumihiko Sano, Gunma (JP); Naoki Matsubara, Gunma (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: AJINOMOTO CO., INC., Tokyo (JP)

(21) Appl. No.: 11/135,436

(22) Filed: May 24, 2005

(30) Foreign Application Priority Data
May 25, 2004 (JP) 2004-155151

(51) Int. Cl. A23C 3/00

(52) U.S. Cl. 426/523

(57) ABSTRACT

A method of preparing industrially and inexpensively fried rice having nice-smelling, well-harmonized taste, soft on the inner side of the grains of the cooked rice and lightly separated at the surfaces thereof, and also suited to be freeze-preserved is disclosed. The method of preparing fried rice, including a rice washing step, a rice immersion step, a rice cooking step and a rice frying step. In this method, two frying steps 11, 15 are carried out in at least two stages out of a stage between a rice washing step 10 and rice immersion step 13, a stage between the immersion step 13 and cooking step 14, an intermediate stage of the cooking stage 14, and a latter stage of the cooking step 14, for example, in a stage between the washing step 10 and immersion step 13, and the latter stage of the cooking step 14.

### BACKGROUND OF THE INVENTION

I. Field of the Invention

The present invention relates to a method of preparing fried rice represented by a Chinese dish of fried rice with eggs, shrimps, etc., and a method of preparing refrigerated fried rice, and more particularly to a method of preparing fried rice suitable to be freeze-preserved and capable of obtaining from freeze-preserved fried rice high-quality fried rice by thawing the same in a microwave oven.

II. Description of the Related Art

A method of industrially preparing fried rice, including a washing step of washing rice to be cooked, an immersion step of immersing the washed rice in water, a cooking step of boiling the immersed rice and a frying step of frying rice has heretofore been known, in which the frying step is carried out by using a machine, such as a rotary frying machine.

The industrially prepared fried rice is generally produced so that the fried rice suits to be freeze-preserved. The methods of industrially preparing fried rice and for obtaining high-quality refrigerated fried rice include a method of preparing fried rice, having steps of frying the rice, which has been subjected to an immersion step of immersing the washed rice in water, with fat added thereto; cooking the fried rice; agitating the cooked rice by adding fat thereto while cooling the rice; cooking ingredients separately from the cooked rice and refrigerating the cooked ingredients; and mixing the ingredients with the refrigerated rice when the ingredients and rice are thawed and cooked (see, for example, JP-A-52-64439), a method of preparing fried rice, having the steps of frying the cooked rice which has just been subjected to a cooking step, and adding heated seasonings to the cooked rice which has just been subjected to the frying step (see, for example, JP-A-2-255049), and a method of preparing fried rice, having the step of supplying water supplementally to the cooked rice which has just been subjected to a frying step (see, for example, JP-A-2002-330714).

In order to fry the rice excellently, it is demanded that the rice be cooked in a pan heated to a high temperature with powerful fire in a short period of time. When materials the time for passing the heat therethrough is various are used in a combined manner as ingredients, it is necessary that the time for heating the ingredients be regulated. When seasonings, such as salt and soy sauce are added to the materials, the water is sucked out from the materials due to the effect of the osmotic pressure. Therefore, it is necessary that the seasonings be added to the materials according to a cook's own judgement.

However, in these related art methods, the rotary frying machine and fat cannot be heated sufficiently in advance since the frying step is carried out continuously. In order to fry the cooked rice sufficiently until the surface of the rice come to have an impression that the rice has really been fried, the water in the interior of the cooked rice is lost correspondingly, and the rice tended to become hard. Moreover, since the surface of the cooked rice, etc. cannot be heated with powerful fire, the taste peculiar to the materials which increases by frying the materials, and the fragrance and pleasance of the fat lower. In addition, the quality of the fried rice is liable to vary during the freeze-preservation thereof.

The ingredients and cooked rice were separately cooked and refrigerated, and on thawing and cooking, they are mixed with each other and fried together at once, so that the taste of the ingredients rarely infiltrated into the cooked rice and fat. Moreover, since the seasonings were added at once to the cooked rice and ingredients in the non-powerful fire-heated state, the water came out easily from the materials. Therefore, it was difficult to display an impression of lightly surfaced fried rice.

### SUMMARY OF THE INVENTION

Under the circumstances, the present invention aims at providing a method of preparing industrially and at a low cost fried rice and refrigerated fied rice, having fragrance and harmonized taste, and internally swollen grains of cooked rice and apparently lightly-surfaced grains thereof, and suited to be freeze-preserved.

To achieve this object, a first aspect relates to a method of preparing fried rice, including a washing step of washing rice to be cooked; an immersion step of immersing the washed rice in water; a cooking step of boiling the immersed rice; and at least two frying steps of frying rice;
the washing step, immersion step and cooking step being carried out in the order mentioned; and
the at least two frying steps being carried out at least two stages selected from the group consisting of at least one stage between the washing step and the immersion step, at least one stage between the immersion step and the cooking step, at least one stage during the cooking step, and at least one stage after the cooking step.

In a second aspect, the frying step is carried out at least once after the cooking step, and, in a third aspect, the frying step is carried out at least once between the immersion step and the cooking step and/or during the cooking step, admixing homogenized or beaten eggs with the rice before or during the frying step(s).

In a fourth aspect, before or during each of the frying steps, ingredients and/or seasoning(s) is(are) added to the rice.

In a fifth aspect, a freezing step of freezing the fried rice obtained by the method according to any one of the first to the fourth preparation methods is comprised.

Owing to the first to third aspects, it is possible to put cooked rice in an excellent fried state by using an automatic frying machine, and obtain fried rice having fragrant, harmonized taste and internally swollen and lightly surfaced grains of rice and suited to be freeze-preserved. In the third aspect, fried rice having a strong smell of the fried eggs and a fine flavor is obtained. Since the frying steps are carried out in three stages selected from the group consisting of at least one stage between the immersion step and the cooking step, at least one stage during the cooking step, and at least one stage after the cooking step, the high-quality fried rice can be obtained at a high yield. This fried rice is suited, especially, to be freeze-preserved. When this fried rice is refrigerated and then thawed in a microwave oven, high-quality fried rice can be eaten.

Owing to the fourth aspect, the ingredients through which the heat is difficult to pass, the ingredients and seasonings the taste of which easily comes out can be fried in the mentioned order with the cooked rice, so that the taste of the ingredients can be infiltrated into the cooked rice and fat excellently. Moreover, the ingredients can be fried in an excellent condition, and fried rice of good taste can be obtained. When the time at which the seasonings are added to the cooked rice is regulated so that the water is not sucked from the materials to as great an extent as possible, the taste of the seasonings can be infiltrated into the cooked rice.

Owing to the fifth aspect, refrigerated fried rice suited to be freeze-preserved, and becoming excellent fried rice when this freeze-preserved fried rice is thawed on a microwave oven can be obtained.

The fried rice defined in the present invention means seasoned rice cooked by frying the same with fat, including, for embodiment, Chinese dish of fried rice with eggs and shrimps, pilaf, chicken and rice fried and seasoned with tomato ketchup, buttered rice, etc., and produced industrially, especially, in such a manner that the fried rice is suited to be freeze-preserved.

The washing step of washing rice to be cooked can be carried out by a known method. The washing of rice may be done manually, or can be done by using a suitable rice washing machine. In the immersion step of immersing the washed rice in water, the rice may be immersed in room temperature water for 15 to 120 minutes, i.e., this step can be carried out by a regular method. Alternatively, the immersion step may be carried out by leaving the washed rice to stand for, e.g., about 15 minutes to 120 minutes, after draining off the water on the surface of the rice grains. Even by this method, since the rice grains are wetted with the water used for the washing, water is absorbed by the rice grains. Such a step wherein the rice is left to stand under wetted condition is also called the “immersion step” in the present invention. By this step, elution of components of rice into the water in which the rice grains are immersed may advantageously be prevented. Before draining the water, the rice may be immersed in water for a short period of time (e.g., 30 minutes or less) and then the water may be drained off, followed by leaving the rice to stand as mentioned above. The cooking step of boiling the immersed rice is a regular cooking step carried out with cooking water added to the immersed rice, or the cooking step can be carried out by a rice steaming step in which the rice is subjected to high-temperature steam. Both the regular cooking step and steaming step can be used in a combined state.

The frying step is carried out in at least two stages selected from the group consisting of at least one stage between the washing step and the immersion step, at least one stage between the immersion step and the cooking step, at least one stage during the cooking step, and at least one stage after the cooking step. When one of the frying steps carried out in the above-mentioned two stages is executed in the stage after the cooking step, an impression that the rice has really been fried can further be improved. When one of the frying steps carried out in at least the above-mentioned two stages is executed in the stage between the immersion step and the cooking step, the smell of the fat fried without being interrupted by the water can be infiltrated into the interior of the grains of the rice. When homogenized eggs are added to and mixed with the rice before the frying step is carried out, the smell of the fried eggs can be infiltrated sufficiently into the interior of the grains of the rice.

When the frying step of frying rice is carried out in three stages selected from the group consisting of one stage between the immersion step and the cooking step, one stage during the cooking step, and one stage after the cooking step, an impression that the cooked rice has really been fried, an impression that the fat and ingredients have really been fried, and the balance of the seasonings can be brought close to an optimum condition.

The ingredients, seasonings and fat to be used may be arbitrarily determined. The ingredients capable of being used in the invention include various kinds of materials, for embodiment, meat, such as beef, pork, chicken, etc., fishes and shellfishes, such as shrimps, crabs, cuttlefishes, salmons, scallops, etc., vegetables, such as carrots, onions, green peppers, mushrooms, bamboo shoots, green peas, garlic, ginger, etc., and eggs, etc. Various kinds of seasonings, such as pepper, salt, soy sauce, savory seasonings, curry powder, sauce, ketchup, Tobanjan, etc. can be used. In addition, the fats capable of being used in the invention include salad oil, butter, sesame oil, olive oil, peanut oil, lard, etc. The addition amount of ingredients, seasonings and fats can be determined selectively in accordance with the kind of the fried rice.

The step of refrigerating the fried rice is not specially limited. The refrigeration of the fried rice can be carried out by a mechanical refrigerating unit, and by a gas-type refrigerating unit using dry ice, etc. When a refrigerating step in which the fried rice is agitated as it is unloosened is carried out, the fried rice can be refrigerated in a loosened state. The refrigerated fried rice can be eaten after it is heated in a microwave oven.

### BRIEF DESCRIPTION OF THE DRAWINGS

FIG. 1 is a flow chart showing the production steps for the fried rice of Embodiment 1;

FIG. 2 is a flow chart showing the production steps for the fried rice of Embodiment 2;

FIG. 3 is a flow chart showing the production steps for the fried rice of Embodiment 3;

FIG. 4 is a flow chart showing the production steps for the fried rice of Embodiment 4;

FIG. 5 is a flow chart showing the production steps for the fried rice of Embodiment 5;

FIG. 6 is a flow chart showing the production steps for the fried rice of Embodiment 6; and

FIG. 7 is a flow chart showing the production steps for the fried rice of Comparative examples 1 to 5.

### DETAILED DESCRIPTION OF THE PREFERRED EMBODIMENTS

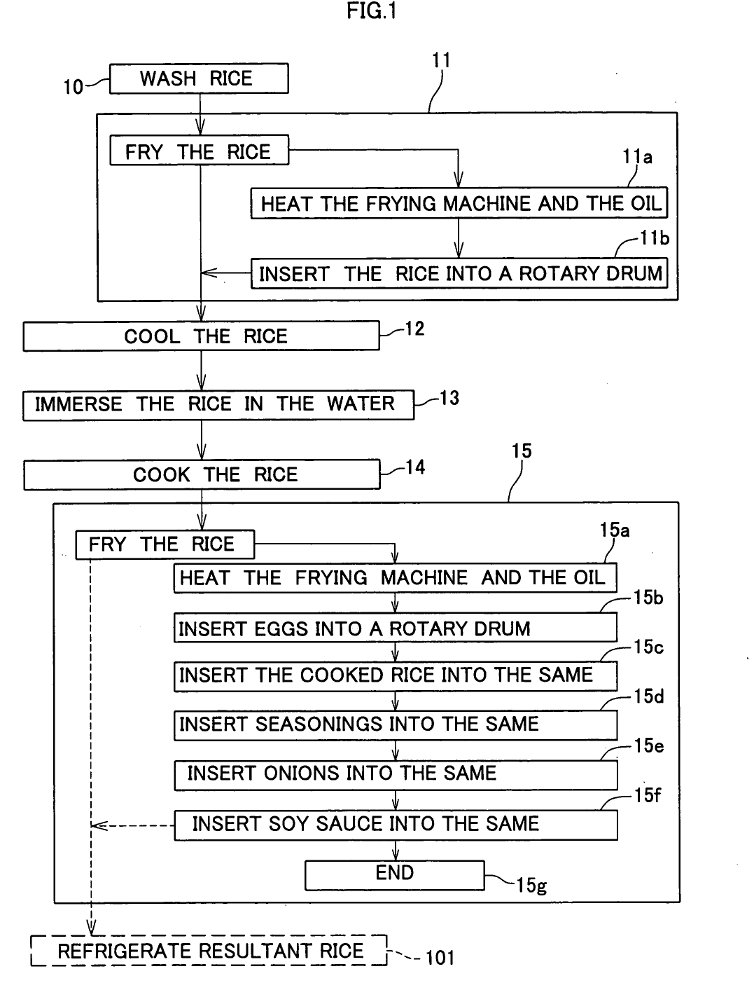

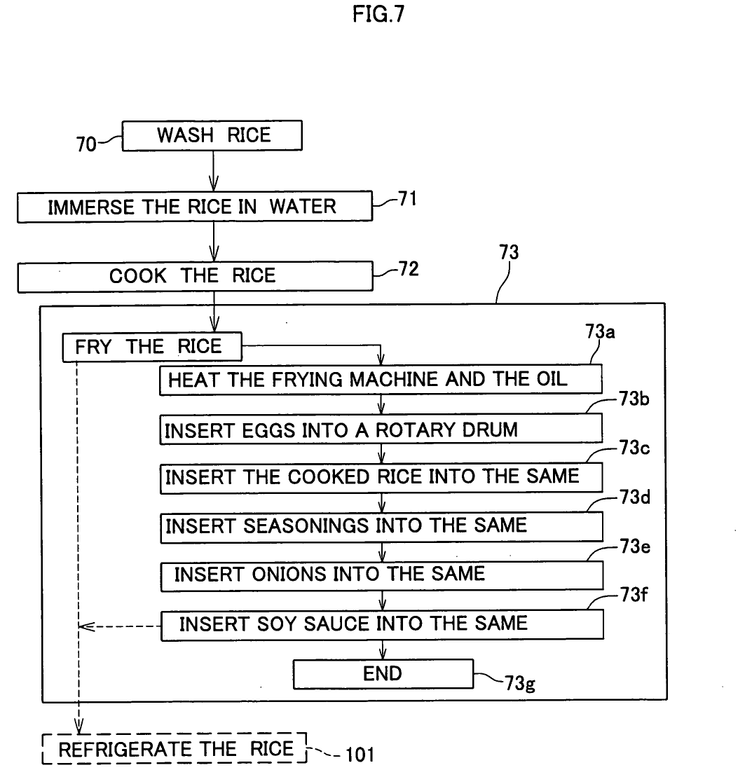

The present invention will now be described on the basis of each embodiment thereof and comparative examples. FIGS. 1 to 6 are flow charts showing the embodiments of the methods of preparing fried rice (refrigerated fried rice) according to the present invention. FIG. 7 is a flow chart showing an embodiment of a related art method of preparing fried rice (refrigerated fried rice).

### Embodiment 1

Fried rice was prepared by using 500 g of rice, in accordance with a preparation steps shown in FIG. 1. The rice was washed by a regular method in a washing step of washing rice to be cooked 10. After the water was swished off sufficiently from the rice, the rice was fried in a first frying step of frying rice 11. This frying step 11 was carried out by using a rotary frying machine (name of product: Rotary Chef (registered trademark). 33 g of salad oil was inserted into a rotary drum, which was then heated to a surface temperature of 200° C. After the drum was heated to this temperature (Step 11a), the rice finished being subjected to the washing step 10 was inserted into the rotary drum (Step 11b), and the rice was fried for two minutes as the drum is rotated. In a cooling step 12, the rice finished being subjected to the frying step 11 was spread over a tray and cooled by leaving the fried rice as it was for ten minutes. In an immersion step 13, the rice finished being subjected to the cooling step 12 was inserted into a pot of a rice cooker, and 660 g of rice cooking water was added to the pot so that a total preparation weight became 1193 g. The rice was immersed in the mentioned water for thirty minutes. The rice finished being subjected to the immersion step 13 was cooked in a cooking step of boiling the immersed rice 14 by using a household rice cooker.

The cooked rice and ingredients finished being subjected to the cooking step 14 were then divided into three equal parts respectively, and these three parts were subjected to a second frying step 15 separately. In this frying step 15, 11 g of salad oil was first inserted into the rotary drum of the rotary frying machine, which was then heated to a surface temperature of 200° C. (Step 15a). The rotational frequency of the rotary frying machine was then set maximum, and 225 g of homogenized eggs were inserted into the rotary drum (Step 15b). When ten seconds elapsed after the insertion of the eggs, cooked rice was inserted into the rotary drum (Step 15c), and, when one minute and thirty seconds elapsed after the insertion of the eggs, seasonings (1.25 g of white pepper, 11.25 g of salt and 3.75 g of savory seasoning) (Step 15d). When one minute and forty-five seconds elapsed after the insertion of the eggs, 125 g of onion cut into tiny pieces was inserted into the rotary drum (Step 15e), and, when one minute and fifty seconds elapsed after the insertion of the eggs, 18.75 g of soy sauce (Step 15f). When two minutes elapsed after the insertion of the eggs, the heating of the rotary drum was stopped (Step 15g) and the completed fried rice was taken out. The final weight of the fried rice became about 1224 g. The total weight of the water added was 660 g, and that of the salad oil 66 g.

### Embodiment 2

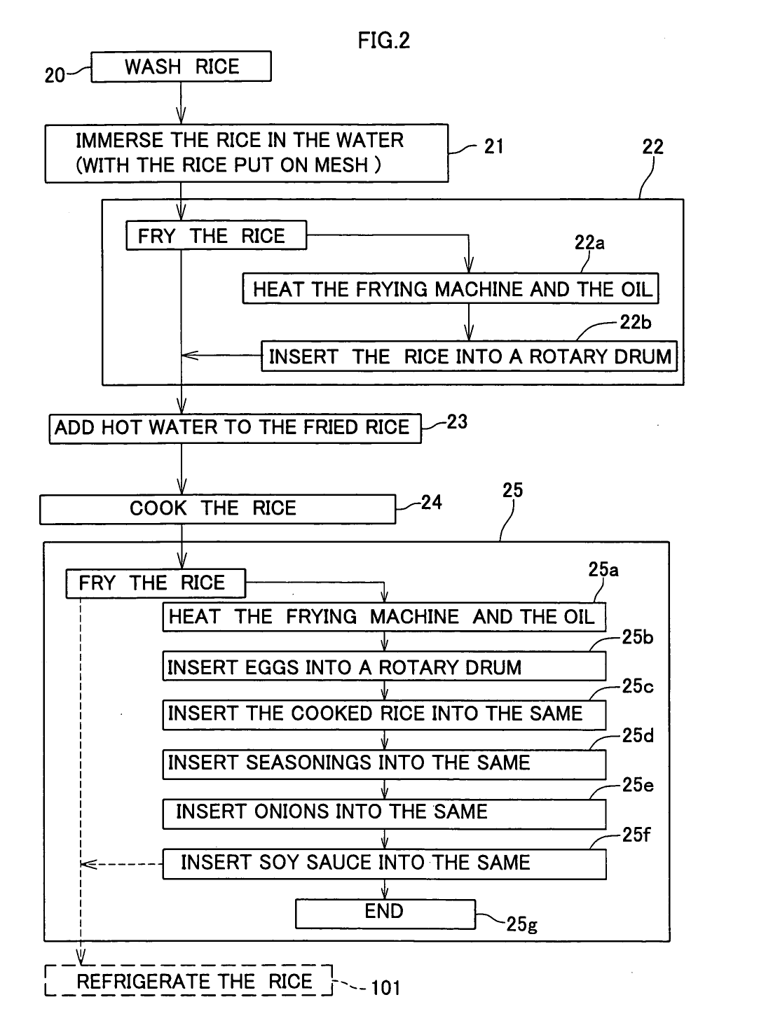

Fried rice was prepared by using 500 g of rice, in accordance with preparation steps shown in FIG. 2. The rice was washed by a regular method in a washing step of washing rice to be cooked 20, and, in an immersion step of immersing the washed rice in water 21, the rice finished being subjected to the washing step 20 was placed on a mesh for thirty minutes, and the resultant rice was immersed in a water cut-off state in the water. In a first frying step of frying rice 22, 33 g of salad oil was inserted into a rotary drum of a rotary frying machine, which was then heated (Step 22a) to a surface temperature of 200° C. The rice finished being subjected to the immersion step 21 was inserted into the rotary drum (Step 22b) and fried for two minutes as the rotary drum is rotated. In a hot water adding step 23, the rice finished being subjected to the frying step 22 was inserted into a pot of a rice cooker, and hot water of about 98° C. was inserted into the pot so that a total preparation weight became 1193 g. The rice finished being subjected to the hot water adding step 23 was cooked immediately in a cooking step 24. The weight of the rice cooked became 1072 g.

The cooked rice finished being subjected to the cooking step 24 and ingredients were divided into three equal parts, which were followed by carrying out a second frying step of frying rice 25. The quantities of the eggs, seasoning, onions and salad oil were set equal to those of the same used in the frying step of frying rice 15. In the frying step 25, salad oil was inserted into the rotary drum of the rotary rice frying machine, which was then heated to a surface temperature of 200° C. (Step 25a), and the rotational frequency of the rotary rice frying machine being then set maximum, the homogenized eggs were then inserted into the rotary drum (Step 25b). When ten seconds elapsed after the insertion of the eggs into the rotary drum, cooked rice was inserted thereinto (Step 25c), and, when one minute and thirty seconds elapsed after the insertion of the eggs, seasonings (white pepper, salt and savory seasoning) (Step 25d). When one minute and forty-five seconds elapsed after the insertion of the eggs, onion cut into tiny pieces were inserted into the rotary drum (Step 25e), and, when one minute and fifty seconds elapsed after the insertion of the eggs, soy sauce (Step 25f). When two minutes elapsed after the insertion of the eggs into the rotary drum, the heating of the rotary drum was stopped (Step 25g), and the completed fried rice was taken out. The final weight of the fried rice, became about 1224 g and the total weight of the water and hot water was 660 g, and the total weight of the salad oil 66 g.

### Embodiment 3

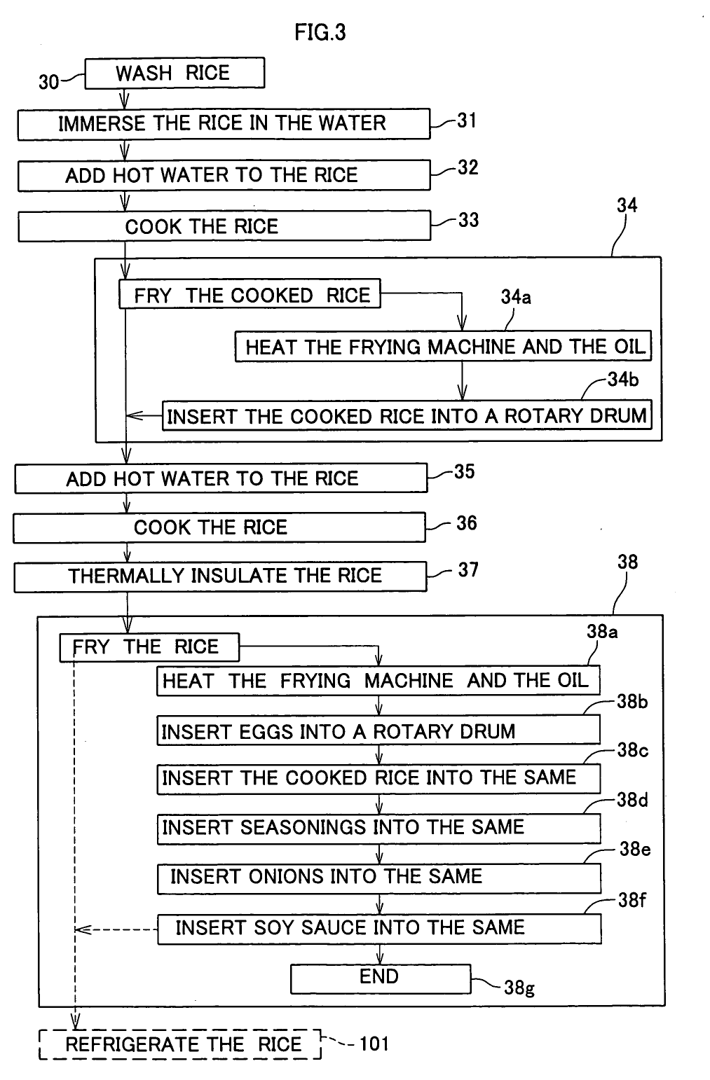

The fried rice was prepared by using 500 g of rice, in accordance with the production steps shown in FIG. 3. The rice was washed by a regular method in a washing step of washing rice to be cooked 30. In an immersion step of immersing the washed rice in water 31, the rice finished being subjected to the washing step 30 was immersed in the water for one hour. In a hot water adding step 32, the rice finished being subjected to the immersion step 31 was inserted into a pot of a rice cooker, and also hot water of about 98° C. so that a total preparation quantity became 1000 g. The rice finished being subjected to the hot water adding step 32 was cooked immediately a cooking step of boiling the immersed rice 33. The weight of the cooked rice became 915 g.

In a first frying step of frying rice 34, 33 g of salad oil was inserted into a rotary drum of a rotary rice frying machine, which was then heated (Step 34a) to a surface temperature of 200° C. The cooked rice finished being subjected to the cooking step 33 was inserted into the rotary drum (Step 34b), and fried for two minutes. The weight of the cooked rice finished being subjected to the frying step 34 became 830 g. After the frying step of frying rice 34 finished, the heating power of the rotary frying machine was weakened, and the rotation of the machine was stopped. In a hot water adding step 35 and a rice cooking step 36, hot water of about 98° C. was inserted into the rotary drum little by little as the cooked rice finished being subjected to the rice frying step 34 was lightly agitated. The rice was cooked again as it was heated for about five minutes. A total quantity of the hot water inserted was 370 g. The cooked rice finished being subjected to the cooking step 36 was taken out from the rotary drum, and transferred to a pot of a rice cooker. The resultant cooked rice was thermally insulated in a thermal insulation step 37 for about fifteen minutes. The weight of the cooked and thermally insulated rice became 1072 g.

The cooked rice and ingredients finished being subjected to the thermal insulation step 37 were divided into three equal parts, which were subjected respectively to a second frying step of frying rice 38. In this step, the quantities of the eggs, seasoning, onion and salad oil were equal to those of the same materials used in the frying step 15. In the frying step 38, salad oil was inserted first in the rotary drum of the rotary frying machine, which was then heated to a surface temperature of 200° C. (Step 38a). The rotational frequency of the rotary frying machine was then set maximum, and homogenized eggs were inserted into the rotary drum (Step 38b). When ten seconds elapsed after the eggs had been inserted into the rotary drum, cooked rice was inserted thereinto (Step 38c). When one minute and thirty seconds elapsed after the insertion of the eggs, seasonings (white pepper, salt and savory seasoning) were inserted into the rotary drum (Step 38d), and, when one minute and forty-five seconds elapsed after the insertion of the eggs, onions cut into tiny pieces were inserted into the rotary drum (Step 38e). When one minute and fifty seconds elapsed after the insertion of the eggs, soy sauce was inserted thereinto (Step 38f). When two minutes elapsed after the insertion of the eggs, the heating of the frying machine was stopped (Step 38g), and the completed fried rice was taken out. The final weight of the fried rice became about 1224 g. The total weight of the water and hot water added was 660 g, and the total weight of the salad oil 66 g.

### Embodiment 4

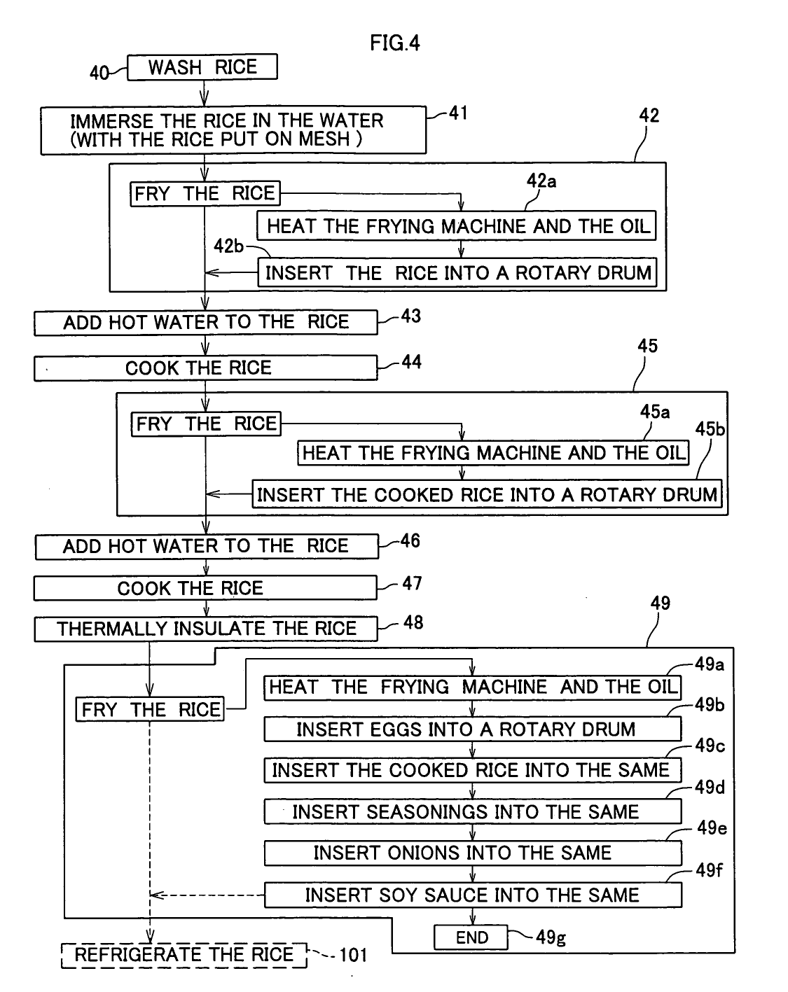

Fried rice was prepared by using 500 g of rice, in accordance with the production steps shown in FIG. 4. The rice was washed by a regular method in a washing step of washing rice to be cooked 40, and the rice finished being subjected to the washing step 40 was put on a mesh for thirty minutes in an immersion step of immersing the washed rice in water 41. The washed rice in a water cut-off state was immersed in the water in the immersion step 41. In a first frying step of frying rice 42, 24 g of salad oil was inserted into a rotary drum of a rotary frying machine, which was then heated (Step 42a) to a surface temperature of 200° C. The rice finished being subjected to the immersion step 21 was inserted into the rotary drum (Step 42b), and fried for two minutes as the rotary drum is rotated. In a hot water adding step 43, the rice finished being subjected to the frying step 42 was inserted into a pot of a rice cooker, and then hot water of about 98° C. so that the total weight of preparation became 1022 g. In a cooking step 44, the rice finished being subjected to the adding hot water step 43 was cooked immediately. The weight of the rice cooked became 937 g.

The cooked rice and ingredients finished being subjected to the cooking step 44 were then divided into three parts respectively, which were subjected separately to a second frying step of frying rice 45. In the frying step 45, 7 g of salad oil was inserted first into a rotary drum of a rotary frying machine, which was then heated (Step 45a) to a surface temperature 200° C. The cooked rice was then inserted into the rotary drum (Step 45b), and fried for two minutes. The weight of the cooked rice finished being subjected to the frying step 45 became 845 g. After the frying step 45 finished, the heating power of the rotary frying machine was weakened, and the rotation thereof was stopped. In a hot water adding step 46 and a cooking step 47, hot water of about 98° C. was inserted little by little into the rotary drum as the cooked rice finished being subjected to the frying step 45 was lightly agitated. The cooked rice was cooked again by heating the same for about five minutes. A total quantity of the hot water inserted into the rotary drum was 370 g. The cooked rice finished being subjected to the cooking step 47 was taken out from the rotary drum, and transferred to a pot of a rice cooker, for heat-retaining for 15 minutes at a heat-retaining step 48. The weight of the cooked and thermally insulated rice became 1084 g.

In a third frying step of frying rice 49 subsequently carried out, eggs, seasonings and onions the quantities of which were equal to those thereof in the frying step 15 in Embodiment 1 were used. First, 7 g of salad oil was inserted into the rotary drum of the rotary frying machine, which was then heated (Step 49a) to a surface temperature of 200° C., and homogenized eggs were inserted (Step 49b) into the rotary drum with the rotational frequency of the rotary frying machine set maximum. When ten seconds elapsed after the insertion of the eggs, cooked rice was inserted into the rotary drum (Step 49c), and, when one minute and thirty seconds elapsed after the insertion of the eggs, seasonings (white pepper, salt and savory seasoning) (Step 49d). When one minute and forty-five seconds elapsed after the insertion of the eggs, onions cut into tiny pieces were inserted into the rotary drum (Step 49e), and, when one minute and fifty seconds elapsed after the insertion of the eggs, soy sauce (Step 49f). When two minutes elapsed after the insertion of the eggs, the heating of the frying machine was stopped (step 49g), and completed fried rice was taken out. The final weight of the fried rice became about 1224 g. The total weight of the water and hot water added was 660 g, and that of the salad oil 66 g.

### Embodiment 5

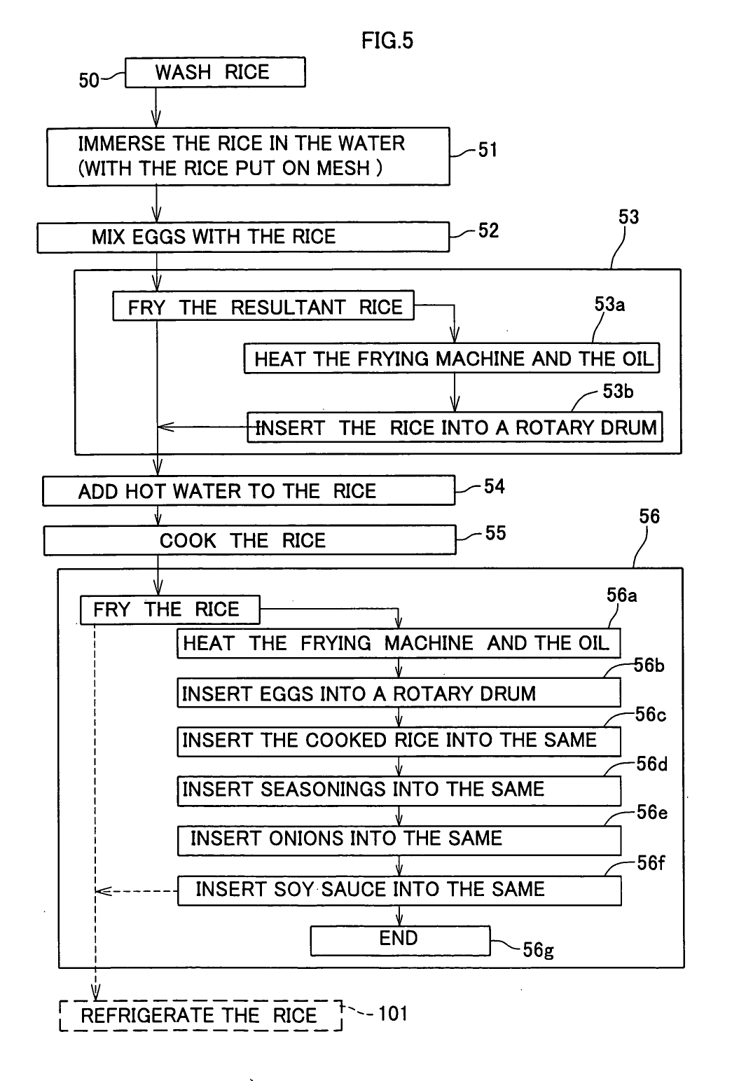

Fried rice was prepared by using 500 g of rice, in accordance with the production steps shown in FIG. 5. In a washing step of washing rice to be cooked 50, the rice was washed by a regular method, and, in an immersion step of immersing the washed rice in a water 51, the rice finished being subjected to the washing step 50 was put on a mesh for thirty minutes and immersed in a water cut-off state in the water. In an egg mixing step 52, 50 g of homogenized eggs were admixed with the immersed rice finished being subjected to the immersion step 51. In a first frying step of frying rice 53, 33 g of salad oil was inserted into a rotary drum of a rotary frying machine, which was then heated (Step 53a) to a surface temperature of 200° C., and the rice finished being subjected to the egg mixing step 52 was then inserted into the rotary drum (Step 53b) and fried for two minutes as the rotary drum was rotated. In a hot water adding step 54, the rice finished being subjected to the frying step 53 was inserted into a pot of a rice cooker, and hot water of about 98° C. was also inserted thereinto so that the total weight of the preparation became 1193 g. In a cooking step 55, the rice finished being subjected to the hot water adding step 54 was immediately cooked. The weight of the rice cooked became 1072 g.

The cooked rice and ingredients finished being subjected to the cooking step 55 were then divided into three parts respectively, and the three parts were subjected separately to a second frying step of frying rice 56. In the frying step 56, 11 g of salad oil was first inserted into the rotary drum of the rotary frying machine, which was then heated (Step 56a) to a surface temperature of 200° C., and 175 g of homogenized eggs were inserted thereinto (Step 56b) with the rotational frequency of the rotary frying machine set maximum. When ten seconds elapsed after the insertion of the eggs, the cooked rice was inserted into the rotary drum (Step 56c), and, when one minute and 30 seconds elapsed after the insertion of the eggs, seasonings (1.25 g of white pepper, 11.25 g of salt and 3.75 g of savory seasoning) (Step 56d). When one minute and forty-five seconds elapsed after the insertion of the eggs, 125 g of onions cut into tiny pieces were inserted into the rotary drum (Step 56e), and, when one minute and fifty seconds elapsed after the insertion of the eggs, 18.75 g of soy sauce (Step 56f). When two minutes elapsed after the insertion of the eggs, the heating of the frying machine was stopped (Step 56g), and the completed fried rice was taken out. The final weight of the fried rice was about 1224 g. The total weight of the water and hot water added was 660 g, and the total weight of the salad 66 g.

### Embodiment 6

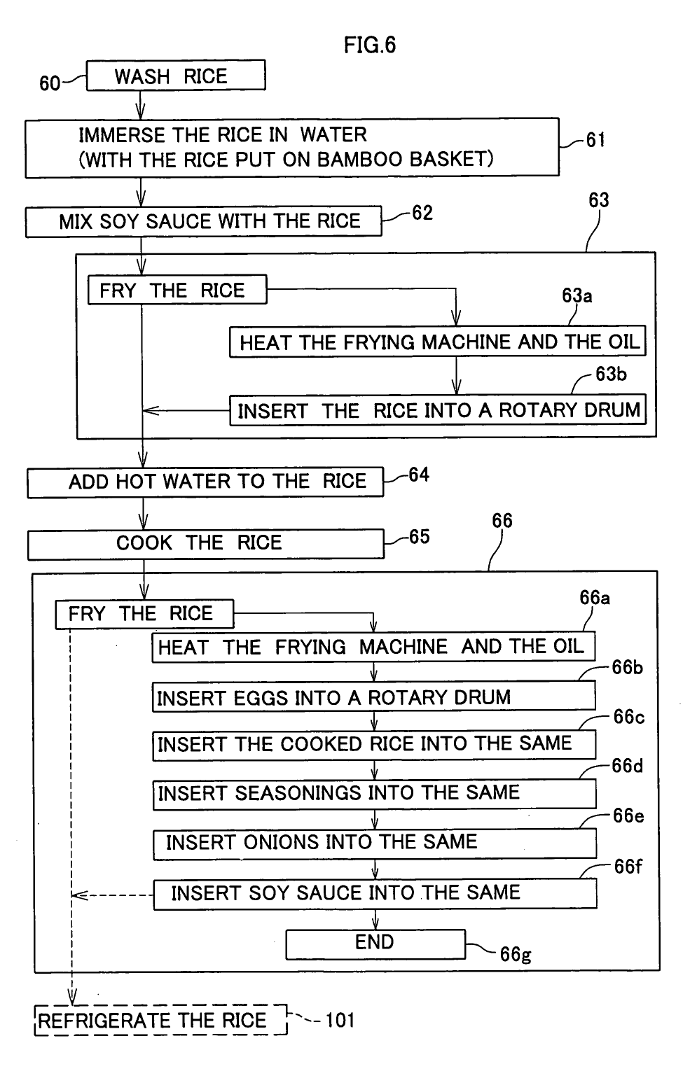

Fried rice was prepared by using 500 g of rice, in accordance with the production steps shown in FIG. 6. In a washing step of washing rice to be cooked 60, the rice was washed by a regular method, and, in an immersion step of immersing the washed rice in water 61, the rice finished being subjected to the washing step 60 was put on a mesh for thirty minutes. The rice was immersed in water cut-off state in the water. In a soy sauce mixing step 62, 7 g of soy sauce was mixed with the immersed rice finished being subjected to the rice immersion step 61. In a first frying step of frying rice 63, 32 g of salad oil was inserted into a rotary drum of a rotary frying machine, which was heated (Step 63a) to a surface temperature of 200° C., and the rice finished being subjected to the of soy sauce mixing step 62 was also inserted thereinto (Step 63b) The resultant rice was fried for two minutes as the rotary drum is rotated. In a hot water adding step 64, the rice finished being subjected to the frying step 63 was inserted into a pot of a rice cooker, and hot water of about 98° C. as well so that the total weight of the preparation became 1193 g. In a rice cooking step 65, the rice finished being subjected to the hot water adding step 64 was immediately cooked. The weight of the rice cooked became 1072 g.

The cooked rice and ingredients finished being subjected to the cooking step 65 were divided into three parts respectively, and these parts were subjected separately to a second frying step of frying rice 66. In the frying step 66, 11 g of salad oil was inserted into a rotary drum of a rotary frying machine, which was then heated (Step 66a) to a surface temperature of 200° C. 225 g of homogenized eggs were inserted (Step 66b) into the rotary drum with the rotational frequency of the rotary frying machine set maximum. When ten seconds elapsed after the insertion of the eggs, the cooked rice was inserted (Step 66c) into the rotary drum, and, when one minute and thirty seconds elapsed after the insertion of the eggs, seasonings (1.25 g of white pepper, 11.25 g of salt and 3.75 g of savory seasoning) (Step 66d). When one minute and forty-five seconds elapsed after the insertion of the eggs, 125 g of onions cut into tiny pieces were inserted (Step 66e) into the rotary drum, and, when one minute and fifty seconds elapsed after the insertion of the eggs, 11.75 g of soy sauce (Step 66f). When two minutes elapsed after the insertion of the eggs, the heating of the rotary frying machine was stopped (Step 66g), and the completed fried rice was taken out. The final weight of the fried rice became about 1224 g. The total weight of the water and hot water added was 660 g, and the total weight of the salad oil 66 g.

### COMPARATIVE EXAMPLE 1

Fried rice was prepared by using 500 g of rice, in accordance with the related art production steps shown in FIG. 7. In a washing step of washing rice to be cooked 70, the rice was washed by a regular method, and, in an immersion step of immersing the washed rice in water 71, the rice finished being subjected to the washing step of washing rice to be cooked 70 was immersed in rice cooking water of 20° C. for thirty minutes. The rice cooking water added so that the total weight of preparation became 1150 g was regulated, and the rice finished being subjected to the immersion step 71 was cooked in a cooking step 72. The weight of the rice cooked became about 1100 g.

The cooked rice and ingredients finished being subjected to the cooking step 72 were then divided into three equal parts respectively, which were then separately subjected to a frying step of frying rice 73. In the frying step 73, eggs, seasonings and onions, the quantities of which were equal to those of the same materials used in the frying step 15 in Embodiment 1, were used. First, 22 g of salad oil was inserted into a rotary drum of a rotary frying machine, which was then heated (Step 73a) to a surface temperature of 200° C., and homogenized eggs were then inserted (Step 73b) into the rotary drum with the rotational frequency of the rotary frying machine set maximum. When ten seconds elapsed after the insertion of the eggs, the cooked rice was inserted (Step 73c) into the rotary drum, and, when one minute and thirty seconds elapsed after the insertion of the eggs, seasonings (white pepper, salt and savory seasoning) (Step 73d). When one minute and forty-five seconds elapsed after the insertion of the eggs, onions cut into tiny pieces were inserted into the rotary drum (Step 73e), and, when one minute and fifty seconds elapsed after the insertion of the eggs, soy sauce (Step 73f). When two minutes elapsed after the insertion of the eggs, the heating of the frying machine was stopped, and the completed fried rice was taken out (Step 73g). The final weight of the fried rice became about 1276 g. The total weight of the water added was 650 g, and that of the salad oil 66 g.

### COMPARATIVE EXAMPLE 2

Fried rice was prepared in accordance with the production steps shown in FIG. 7 in the same manner as in Comparative example 1 except that the time of insertion of the ingredients and seasonings in a frying step 73 was changed. In the frying step 73, 22 g of salad oil was first inserted into a rotary drum of a rotary frying machine, which was then heated (Step 73a) to a surface temperature of 200° C. Homogenized eggs were then inserted (Step 73b) into the rotary drum with the rotational frequency of the rotary frying machine set maximum. When ten seconds elapsed after the insertion of the eggs, cooked rice was inserted (Step 73c) into the rotary drum, and, when two minutes elapsed after the insertion of the eggs, seasonings (white pepper, salt and savory seasoning) (Step 73d). When two minutes and fifteen seconds elapsed after the insertion of the eggs, onions cut into tiny pieces were inserted (Step 73e) into the rotary drum, and, when two minutes and twenty seconds elapsed after the insertion of the eggs, soy sauce (Step 73f). When two minutes and thirty seconds elapsed after the insertion of the eggs, the heating of the frying machine was stopped, and completed fried rice was taken out (Step 73g.). The final weight of the fried rice became about 1224 g. The total weight of the water added was 650 g, and that of the salad oil 66 g.

### COMPARATIVE EXAMPLE 3

Fried rice was prepared in accordance with the production steps shown in FIG. 7 in the same manner as in Comparative example 1 except that the time of the insertion of the ingredients and seasonings in a frying step 73 was changed. In the frying step 73, 22 g of salad oil was first inserted into a rotary drum of a rotary frying machine, which was then heated (Step 73a) to a surface temperature of 200° C., and homogenized eggs were inserted (Step 73b) with the rotational frequency of the rotary frying machine set maximum. When ten seconds elapsed after the insertion of the eggs, cooked rice was inserted (Step 73c) into the rotary drum, and, when two minutes and thirty seconds elapsed after the insertion of the eggs, seasonings (white pepper, salt and savory seasonings) (Step 73d). When two minutes and forty-five seconds elapsed after the insertion of the eggs, onions cut into tiny pieces were inserted (Step 73e) into the rotary drum, and, when two minutes and fifty seconds elapsed after the insertion of the eggs, soy sauce (Step 73f). When three minutes elapsed after the insertion of the eggs, the heating of the frying machine was stopped, and completed fried rice was taken out (Step 73g). The final weight of the fried rice became about 1177 g. The total weight of the water added was 650 g, and that of the salad 66 g.

### COMPARATIVE EXAMPLE 4

Fried rice was prepared by using 500 g of rice in accordance with the production steps shown in FIG. 7. A washing step of washing rice to be cooked 70 and an immersion step of immersing the washed rice in water 71 were carried out in the same manner as in Comparative Example 1. In a cooking step of boiling the immersed rice 72, the cooking water to be added to the rice was regulated so that the total weight of preparation became 1100 g, and, in the cooking step 72, the rice finished being subjected to the immersion step 71 was cooked. The weight of the rice cooked became about 1055 g.

The cooked rice finished being subjected to the cooking step 72 and the eggs, seasonings and onions the quantities of which were equal to those of the same materials in Comparative Example 1 were divided into three parts respectively, and a frying step of frying rice 73 was carried out for these three parts separately. First, 22 g of salad oil was inserted into a rotary drum of a rotary frying machine, which was heated (Step 73a) to a surface temperature of 200° C., and homogenized eggs was inserted (Step 73b) into the rotary drum with the rotational frequency of the rotary frying machine set maximum. When ten seconds elapsed after the insertion of the eggs, the cooked rice was inserted (Step 73c) into the rotary drum, and, when one minute and fifteen seconds elapsed after the insertion of the eggs, seasonings (white pepper, salt and savory seasonings) (Step 73d). When one minute and thirty seconds elapsed after the insertion of the eggs, onions cut into tiny pieces were inserted (Step 73e) into the rotary drum, and, when one minute and thirty-five seconds elapsed after the insertion of the eggs, soy sauce (Step 73f). When one minute and forty-five seconds elapsed after the insertion of the eggs, the fire was put out, and the completed fried rice was taken out (Step 73g). The final weight of the fried rice became about 1224 g. The total weight of the water added was 600 g, and that of the salad oil 66 g.

### COMPARATIVE EXAMPLE 5

Fried rice was prepared in accordance with the production steps shown in FIG. 7, in the same manner as in Comparative Example 4 except that the time of insertion of the ingredients and seasonings in the frying step 73 was changed. In the frying step 73, 22 g of salad oil was first inserted into a rotary drum of a rotary frying machine, which was then heated (Step 73a) to a surface temperature of 200°, and homogenized eggs were then inserted (Step 73b) with the rotational frequency of the rotary frying machine set maximum. When ten seconds elapsed after the insertion of the eggs, the cooked rice was inserted (Step 73c) into the rotary drum, and, when one minute and forty-five seconds elapsed after the insertion of the eggs, seasonings (white pepper, salt and savory seasonings) (Step 73d). When two minutes elapsed after the insertion of the eggs, onions were inserted (Step 73e) into the rotary drum, and, when two minutes and five seconds elapsed after the insertion of the eggs, soy sauce (Step 73f). When two minutes and fifteen seconds elapsed after the insertion of the eggs, the heating was stopped, and completed fried rice was taken out (Step 73g). The final weight of the fried rice became about 1177 g. The total weight of the water added was 600 g, and that of the salad oil 66 g.

The quality and yield of fried rice prepared in the above-mentioned Embodiments 1 to 6 and Comparative Examples 1 to 5 will be shown in Table 1.

TABLE 1

| | Embod- | Embod- | Embod- | Embod- | Embodi- | Embodi- | Comparative | Comparative | Comparative | Comparative | Comparative |
|---|---|---|---|---|---|---|---|---|---|---|---|
| | iment 1 | iment 2 | iment 3 | iment 4 | ment 5 | ment 6 | Example 1 | Example 2 | Example 3 | Example 4 | Example 5 |
| Fragrance of | 4 | 4 | 4 | 5 | 5 | 5 | 1 | 3 | 5 | 3 | 4 |
| fried rice | | | | | | | | | | | |
| Impression of | 3 | 4 | 5 | 5 | 4 | 4 | 2 | 3 | 4 | 4 | 3 |
| fried rice being | | | | | | | | | | | |
| eaten | | | | | | | | | | | |
| Taste of fried | 3 | 4 | 5 | 5 | 4 | 4 | 1 | 3 | 5 | 3 | 4 |
| rice | | | | | | | | | | | |
| Final weight | 1224 | 1224 | 1224 | 1224 | 1224 | 1224 | 1276 | 1224 | 1177 | 1224 | 1177 |
| (g) | | | | | | | | | | | |
| Ratio of weight | 245 | 245 | 245 | 245 | 245 | 245 | 255 | 245 | 235 | 245 | 235 |
| of fried rice to | | | | | | | | | | | |
| raw rice (%) | | | | | | | | | | | |
| General | ◯ | ◯ | ◯◯ | ◯◯ | ◯◯ | ◯◯ | X | ◯ | Δ | ◯ | Δ |
| evaluation | | | | | | | | | | | |

5: feel clearly,
4: feel ordinarily,
3: feel weakly,
2: feel little,
1: not substantially feel,
◯◯: very good,
◯: good,
Δ: not so good,
X: bad.

In Comparative Examples 1 to 3 among the related art methods of preparing fried rice, the frying time in Comparative Example 1 was two minutes, and that in Comparative Example 2 two minutes and thirty seconds. The frying time in Comparative Example 3 was three minutes. As shown in Table 1, the fragrance and taste of the fried rice can be rendered good by frying the cooked rice sufficiently up to the condition in Comparative Example 3. However, in the Comparative Example 3, the yield was low, and the cost increased. Moreover, the water in the interior of the cooked rice was lost, and found hard during the eating thereof. In Comparative Examples 4 and 5, the rice was cooked with the quantity of the water added reduced to 600 g in comparison with the quantity thereof added in Comparative Examples 1 to 3 of 650 g. As a result, a comparatively good impression of fried rice could be obtained even when the degree of frying the cooked rice was low but the cooked rice became hard. In Comparative Example 5, the yield was low, and the cost increased.

On the other hand, in Embodiments 1 to 6, good impression of fried rice could be obtained by carrying out a frying step of frying rice a plurality of times without causing the yield to decrease. Especially, in Embodiment 4, in which a frying step of frying rice was carried out three times, the fragrance of the fried rice, the impression thereof obtained while it was eaten and the taste thereof were good, and fried rice of a high yield could be obtained. The fried rice obtained in Embodiment 5 had a strong fragrance of fried eggs as compared with that obtained in Embodiment 2, and the fried rice in Embodiment 6 had a strong nice smell of the soy sauce. The fried rice obtained in both Embodiments 5 and 6 had more harmonized flavor than that obtained in Embodiments 1 and 2.

The fried rice prepared in the above-mentioned Embodiments 1 to 6 and Comparative Examples 1 to 5 was refrigerated by a method of mixing the fried rice with fine dry ice in the Step 101. Such refrigerated fried rice was preserved at −18° C. for one month. The resultant fried rice was thawed in a microwave oven, and the results of comparison of the quality thereof will be shown in Table 2.

TABLE 2

| | Embod- | Embod- | Embod- | Embod- | Embodi- | Embodi- | Comparative | Comparative | Comparative | Comparative | Comparative |
|---|---|---|---|---|---|---|---|---|---|---|---|
| | iment 1 | iment 2 | iment 3 | iment 4 | ment 5 | ment 6 | Example 1 | Example 2 | Example 3 | Example 4 | Example 5 |
| Fragrance of | 3 | 4 | 3 | 5 | 5 | 5 | 1 | 1 | 1 | 1 | 1 |
| fried rice | | | | | | | | | | | |
| Impression of | 3 | 4 | 5 | 5 | 4 | 4 | 1 | 2 | 3 | 3 | 2 |
| fried rice being | | | | | | | | | | | |
| eaten | | | | | | | | | | | |
| Taste of fried | 2 | 3 | 3 | 4 | 3 | 3 | 1 | 2 | 3 | 2 | 3 |
| rice | | | | | | | | | | | |
| General | ◯ | ◯ | ◯ | ◯◯ | ◯◯ | ◯◯ | X | X | Δ | Δ | Δ |
| evaluation | | | | | | | | | | | |

5: feel clearly,
4: feel ordinarily,
3: feel weakly,
2: feel little,
3: not substantially feel,
◯◯: very good,
◯: good,
Δ: not so good,
X: bad.

It was understood from the Table 2 that, when the fried rice obtained in Comparative Examples 1 to 5 was freeze-preserved, the impression of the fried rice which the fried rice has had before it was freeze-preserved was difficult to remain. On the other hand, the impression of the fried rice which the fried rice had had before it was freeze-preserved could remain in Embodiments 1 to 5 even after the fried rice was freeze-preserved. Especially, in Embodiments 4, 5 and 6, the impression of the fried rice which the fried rice had had before it was freeze-preserved could remain in an excellent condition.

1. A method of preparing fried rice, comprising a washing step of washing rice to be cooked; an immersion step of immersing the washed rice in water or keeping the washed rice in wetted condition; a cooking step of boiling the immersed rice; and at least two frying steps of frying rice; said washing step, immersion step and cooking step being carried out in the order mentioned; and said at least two frying steps being carried out at least two stages selected from the group consisting of at least one stage between said washing step and said immersion step, at least one stage between said immersion step and said cooking step, at least one stage during said cooking step, and at least one stage after said cooking step.

2. The method according to claim 1, wherein said frying step is carried out at least once after said cooking step.

3. The method according to claim 1, wherein said frying step is carried out at least once between said immersion step and said cooking step and/or during said cooking step, admixing homogenized eggs with said rice before or during said frying step(s).

4. The method according to claim 1, wherein before or during each of said frying steps, ingredients and/or seasoning(s) is(are) added to said rice.

5. The method according to claim 1, further comprising a freezing step of freezing the fried rice.

6. The method according to claim 2, further comprising a freezing step of freezing the fried rice.

7. The method according to claim 3, further comprising a freezing step of freezing the fried rice.

8. The method according to claim 4, further comprising a freezing step of freezing the fried rice.
